(19) United States
(12) Patent Application Publication
(10) Pub. No.: US 2005/0251792 A1
(43) Pub. Date: Nov. 10, 2005

(54) System for adaptively determining executable application operation characteristics

(76) Inventor: David Wesley Smith, Bridgeport, PA (US)

Correspondence Address: Alexander J. Burke;Intellectual Property Department, 5th Floor, 170 Wood Avenue South, Iselin, NJ, 08830, US

(21) Appl. No.: 10/980,498

(22) Filed: Nov. 3, 2004

Related U.S. Application Data
(60) Provisional application No. 60/568,532, filed on May 6, 2004.

(51) Int. Cl. G06F 9/44

(52) U.S. Cl. 717/131

(57) ABSTRACT

An adaptive system adaptively determines operational characteristics of an executable application. A system for monitoring executable application operation characteristics includes an acquisition processor for acquiring messages from an executable application enabling determination of a duration of the user initiated activity. A data processor determines a duration of the user initiated activity in response to the acquired messages and accumulates information comprising a plurality of duration values for a corresponding plurality of occurrences of the user initiated activity. A data analyzer analyzes accumulated information to identify a duration of execution of a user initiated activity by the executable application exceeding a normal range derived based on the accumulated information.

This is a non-provisional application of provisional applications Ser. No. 60/568,532 by D. W. Smith filed May 6, 2004.

### FIELD OF THE INVENTION

This invention concerns a system for determining executable application operation characteristics such as application response time.

### BACKGROUND INFORMATION

It is necessary to determine executable application operational characteristics (including transactional based application characteristics) such as response time and access time, for example, for a variety of purposes. The operational characteristics are used to optimize a computing configuration, to determine communication bandwidth requirements or to demonstrate that an application meets guaranteed performance thresholds, for example. There are existing systems (from BMC Software, Computer Associates, Compuware and IBM, for example) providing response time monitoring and alerting for transactional-based executable applications. These existing systems typically contain fixed links (hooks) enabling communication and acquisition of data with an underlying operating system or executable application in order to determine operational characteristics. However, the existing systems also involve additional complexity and computational burden resulting from additional feature and function overhead. Further, the additional features and functions exceed those necessary for operational characteristic determination. The additional features and functions provide the ability to troubleshoot a processing system and to examine operation of executable components, for example. The additional features and functions also incur an execution burden on CPU resources. Also, existing systems employ different definitions of operational characteristics such as response time and acquire response time information in different ways. It is desirable for a system to be able to acquire executable application operational characteristics, with reduced processing and computational burden and without requirement for modification of a target application of operation system environment. In addition, existing response time monitoring systems are typically integrated with an operating system or application and collect response time data but fail to aggregate, correlate and analyze the data until a user requests it. A system according to invention principles addresses the identified requirements, deficiencies and associated problems.

### SUMMARY OF THE INVENTION

An adaptive system provides minimally intrusive operational characteristic (e.g., response time) determination and monitoring of an executable application and provides predictive real time operational characteristic alert messages based on learned behavior. A system for monitoring executable application operation characteristics includes an acquisition processor for acquiring messages from an executable application enabling determination of a duration of the user initiated activity. A data processor determines a duration of the user initiated activity in response to the acquired messages and accumulates information comprising a plurality of duration values for a corresponding plurality of occurrences of the user initiated activity. A data analyzer analyzes accumulated information to identify a duration of execution of a user initiated activity exceeding a normal range derived based on the accumulated information.

### BRIEF DESCRIPTION OF THE DRAWING

FIG. 1 shows a system for determining operational characteristics of an executable application, according to invention principles.

FIG. 2 shows a data record structure containing data associated with determination of operational characteristics of an executable application, according to invention principles.

FIG. 3 shows a graphical report presenting operational characteristics of an executable application determined by the system of FIG. 1, according to invention principles.

FIG. 4 shows a tabular report presenting operational characteristics of an executable application determined by the system of FIG. 1, according to invention principles.

FIG. 5 shows a report presenting a detailed analysis of excessive response times of an executable application determined by the system of FIG. 1, according to invention principles.

FIG. 6 shows a flowchart of a process employed by the system of FIG. 1 for determining operational characteristics of an executable application, according to invention principles.

FIG. 7 shows a flowchart of a process employed by an executable application supporting determination of operational characteristics of the executable application, according to invention principles.

### DETAILED DESCRIPTION OF INVENTION

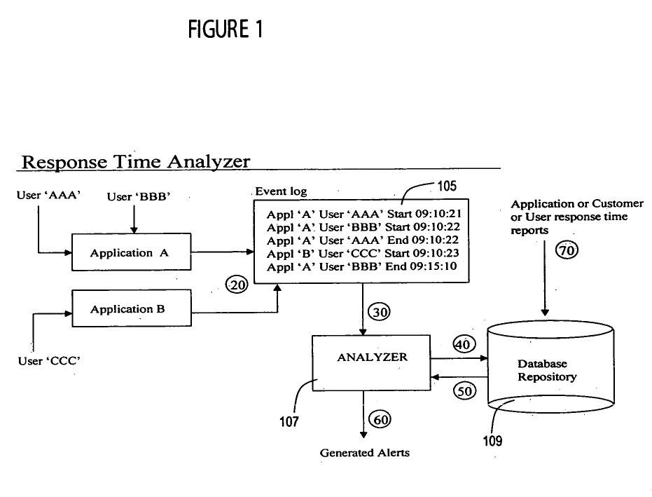

FIG. 1 shows an adaptive system for determining operational characteristics of an executable application. The system determines executable application operational characteristics (e.g., response time) whilst requiring minimal intrusion into the application and operating system. The system provides monitoring of an executable application and adaptively generates alert messages based on real time prediction of operational characteristic through learned behavior. The system provides response time monitoring and alerting without requiring a large infrastructure to support it. In addition, the system adaptively learns acceptable ranges of response times for individual applications as well as for individual users. The system receives input data from an executable application being monitored. This advantageously eliminates the need for interface links (hooks) or overhead between the system and the monitored executable application (as typically required by existing monitoring systems). The system also advantageously has the capability to monitor a subset of users, applications or customers (e.g., customers of an Application Service Provider (ASP) hosting one more applications for use by the customers).

The system compares current response times with corresponding historical, previously acquired response times (such as response times acquired on other days, weeks, months or by different applications or for different customers) in a real time manner. The system adaptively uses this comparison to identify acceptable ranges of executable application response times and reduces application management and configuration time.

An executable application as used herein comprises code or machine readable instruction for implementing predetermined functions including those of an operating system, healthcare information system or other information processing system, for example, in response user command or input. An executable procedure is a segment of code (machine readable instruction), sub-routine, or other distinct section of code or portion of an executable application for performing one or more particular processes and may include performing operations on received input parameters (or in response to received input parameters) and provide resulting output parameters. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device.

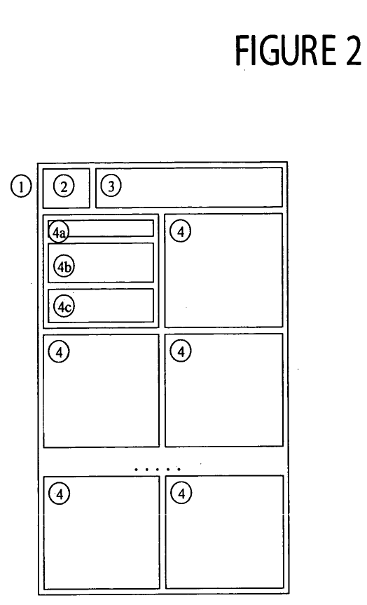

FIG. 2 shows a data record structure containing data associated with determination of operational characteristics of an executable application. The FIG. 1 system employs this record structure and a user interface in monitoring application operational characteristics. The record structure is self-maintaining and employs files of fixed size that do not need to be purged. The database structure allows response time records to be collated and reported by various reporting intervals (by hour, by day, by day-of-week, by week, by month, by year, for example). A response time analyzer in the system advantageously calculates and stores response time for the various intervals substantially immediately that the response time values are determined. This also advantageously allows quick response time reporting and facilitates determination of response time anomalies. In addition, the data record structure is usable to collate operational characteristics for multiple applications and users. This facilitates operational characteristic analysis by an Application Service Provider (ASP) for the purpose of optimization and management of hosted applications. The system enables determination of an excessive response time for a single user or for multiple users, for example.

The FIG. 2 data record structure 1 may be created for one or more of, a particular user, a particular customer of an ASP or a particular application. Record element 2 is a physical record key used for identifying and sorting data record structures. Record element 3 comprises metadata describing components of embedded logical records and an index to the components. A particular instance of response time data is stored in a particular logical record instance 4. The particular instance of response time data may be for a particular time interval (hour, day, week, month etc.) or may be summary data for a particular period of time. Record element 4a stores metadata describing a time frame and identifying type of logical record for logical record 4. This metadata also identifies components of the response time data of logical record 4 that are being measured and provides an index to the components. Record element 4b contains response time criteria (e.g., identifying percentile threshold values as response time alert values) that are used to determine when an exception condition occurs. Further, record element 4c contains other data to be acquired and stored in data record structure 1.

The system employs a web-based user interface that provides a user friendly interface that hides complexity from a user. The user interface allows for flexible generation of reports in response to a wide range of user selectable report creation criteria. Further, as response time data is collected, it is formatted into a desired report format. The system enables various report formats to be quickly generated in response to user command. In addition, the response time data is stored in common data segments for different report creation criteria, enabling mix and match of data segments and facilitating search for common instances of abnormally increased response times.

In the FIG. 1 system, users AAA and BBB access Application A and user CCC accesses Application B. Applications A and B provide messages 20 for storage in event log 105. The messages identify user activities and corresponding times that individual activities start and end. Operational characteristic analyzer 107 analyzes and parses application message data 30 accessed from event log 105 to acquire response time values (and other operational characteristic parameter values). Operational characteristic analyzer 107 provides resultant response time values 40 to database repository 109. Database repository 109 collates and aggregates values 40 to provide various criteria for use in creating reports presenting application operational characteristics to a user. A particular user or system administrator initiates a request for a report presenting operational characteristics of a particular executable application for the particular user via one or more messages 70 communicated to database repository 109. A database management application managing database 109 collates and formats required operational characteristic information to create a report in response to a query containing particular search criteria received in messages 70. The database repository 109 management applicator provides the created report to the particular user.

Operational characteristic analyzer 107 acquires predetermined characteristic thresholds in messages 50 from database repository 109. Analyzer 107 uses the acquired thresholds in determining whether operational characteristics of a particular executable application and a particular user exceed a predetermined threshold. Analyzer 107 generates and communicates alert messages 60 to particular destinations (e.g., particular users) in response to determining an operational characteristic exceeds its predetermined thresholds (such as maximum and minimum thresholds). Operational characteristic analyzer 107 also acquires updates to predetermined characteristic thresholds in messages 50 from database repository 109.

The FIG. 1 system provides real time monitoring and adapts its operation through learned behavior. In exemplary operation, the following activity occurs:
1. User AAA accesses Application A beginning at 9:10:21. Application A generates a message identifying and recording this event in event log 105.
2. User BBB accesses Application A beginning at 9:10:22. Application A generates a message identifying and recording this event in event log 105.
3. At 9:10:22, user AAA receives processing results from Application A. Application A generates a message identifying and recording this event in event log 105.
4. User CCC accesses application B beginning at 9:10:23. Application B generates a message identifying and recording this event in event log 105.
5. At 9:15:10, user BBB receives processing results from application A. Application A generates a message identifying and recording this event in event log 105.

Operational characteristic analyzer 107 accesses and parses the messages stored in event log 105 to identify and extract information needed to determine response time (and other operational characteristic) behavior. In the exemplary operation, analyzer 107 determines response time values from the event log 105 messages as follows.

| | | | | Response |
|---|---|---|---|---|
| Application | User | Start | Finish | time |
| A | AAA | 9:10:21 | 9:10:22 | 0:00:01 |
| A | BBB | 9:10:22 | 9:15:10 | 0:04:48 |
| B | CCC | 9:10:23 | | |

Analyzer 107, applies predetermined response time monitoring rules in acquiring threshold information from database repository 109 and generating alert messages. Specifically, analyzer 107 generates an alert message for Application A and user BBB based on a response time exceeding a two second threshold. The response time for user ‘CCC’ is not yet known at this stage in the exemplary operation, so no alert message is generated for this event.

The system continuously accumulates and aggregates response time records over time and uses the accumulated data to adaptively adjust analysis, alert generation and report generation. The records are processed and stored in database repository 109 maintained by the system. Ultimately this database contains values of typical response times. In the exemplary operation, database repository 109 becomes populated as follows.

| | | | Average | | Worst | |
|---|---|---|---|---|---|---|
| Appln. | User | Last Access | Response Time | Occurrences | Response Time | Occurrences |
| A | AAA | 3/31/04 | 0:00:01 | 451 | 0:00:04 | 2 |
| | | 8:58:85 | | | | |
| A | BBB | 3/30/04 | 0:05:04 | 256 | 0:09:14 | 4 |
| | | 14:51:40 | | | | |
| B | CCC | 3/30/04 | 0:00:02 | 1,761 | 0:00:03 | 45 |
| | | 15:10:10 | | | | |

Analyzer 107 examines and analyzes the accumulated response time records and adaptively adjusts its analysis and alert generation functions based on this analysis. As a result, even though user BBB experiences a 4:48 minute response time, for example, analyzer 107 does not initiate generation of an alert message because the system has determined this is reasonably close to a normal value (average response time value 5 minutes 4 seconds) based on prior activity. This adaptive operation advantageously reduces false alerts.

Continuing the operation example, over time, user AAA alters usage of application A to involve more time consuming activities, initially, analyzer 107 detects an increase in response time and generates alert messages indicating error. However, analyzer 107 accumulates response time values and determines a changed (increased) average response time value indicating the increased response time values are within a reasonable range. As a result, analyzer 107 no longer determines the increased response times to be excessive since they are within guidelines acquired from database repository 109 and analyzer 107 no longer generates alert messages for these response times.

In another example, application A is altered to include an additional function (function A1) that provides a summary result instead of a detailed result. As a consequence, user BBB intermittently experiences a reduced response time upon employing the summary function. This would be expected to result in analyzer 107 either incorrectly generating false alert messages or failing to generate alert messages when genuine excessive response times occur. However, application. A is advantageously adapted to generate new application messages indicating start and stop times of operation of added or changed functions such as summary function A1 in this example. Thereby, analyzer 107 prevents missing of alerts or generation of false alert messages by examining messages from application A to identify new messages indicating added, deleted or changed functions. Specifically, analyzer 107 detects a change in functions provided by Application A (i.e., detects operation of added function A1) by examining application messages stored in event log 105. User operation of added summary function A1 results in an exemplary message classification as follows.

| | | Last | Average | | | |
|---|---|---|---|---|---|---|
| Application | User | Access | Resp Time | Occurrences | Worst | Occurrences |
| A | AAA | 3/31/04 | 0:00:01 | 451 | 0:00:04 | 2 |
| | | 8:58:85 | | | | |
| A | BBB | 3/30/04 | 0:05:04 | 256 | 0:09:14 | 4 |
| | | 14:51:40 | | | | |
| A1 | BBB | 3/30/04 | 0:00:03 | 24 | 0:00:05 | 10 |
| | | 14:22:10 | | | | |
| B | CCC | 3/30/04 | 0:00:02 | 1,761 | 0:00:03 | 45 |
| | | 15:10:10 | | | | |

The adaptation of application A to generate new application messages indicating start and stop times of operation of added or changed functions advantageously enables analyzer 107 to correctly determine response time deviations. In addition, analyzer 107 is also able to examine even log 105 messages to analyze application behavior based on particular day of the week, time of day, month-end for example.

Operational characteristic analyzer 107 provides values 40 to database repository 109 which collates and aggregates values 40 to provide various criteria indicating application behavior that may be used in creating reports for presentation to a user. The criteria indicating application behavior stored in database 109 advantageously addresses problems with existing passive executable application monitoring systems. A specific problem occurs, for example, if there is little or no activity occurring. Under this condition, an existing passive executable application monitoring system may not detect and report a response time of an application that exceeds a normal range as long as minimal activity occurs in the application. In contrast, analyzer 107 and database 109 are aware of typical hourly, daily and weekly application activities and associated response times. This data is used by analyzer 107 to detect response times exceeding a normal range determined for a particular time period such as a particular hour of a day, particular day of a week, particular week of a month or year, for example. Thereby unit 107 generates alert messages upon detection of response times exceeding a normal range determined for such particular time period.

A database management application managing database 109 collates and formats required operational characteristic information to create multiple reports in response to a query containing particular search criteria received in messages 70. The created reports are provided to one or more requesting users. The reports are usable to compare response time activity for a given user or application (with other users, applications etc.) on a day-by-day, week-by-week or month-by-month basis, for example. Since some applications tend to be used in a similar manner based on the day-of-the-week, database 109 supports generation of reports enabling application response time comparison (and other operational characteristic comparison) of a particular day to the same day a week ago, two weeks ago, etc. The reports contain information supporting comparison of different applications or different users within the same application. This type of report would be useful to determine if a user is incorrectly or sub-optimally using a specific application, for example.

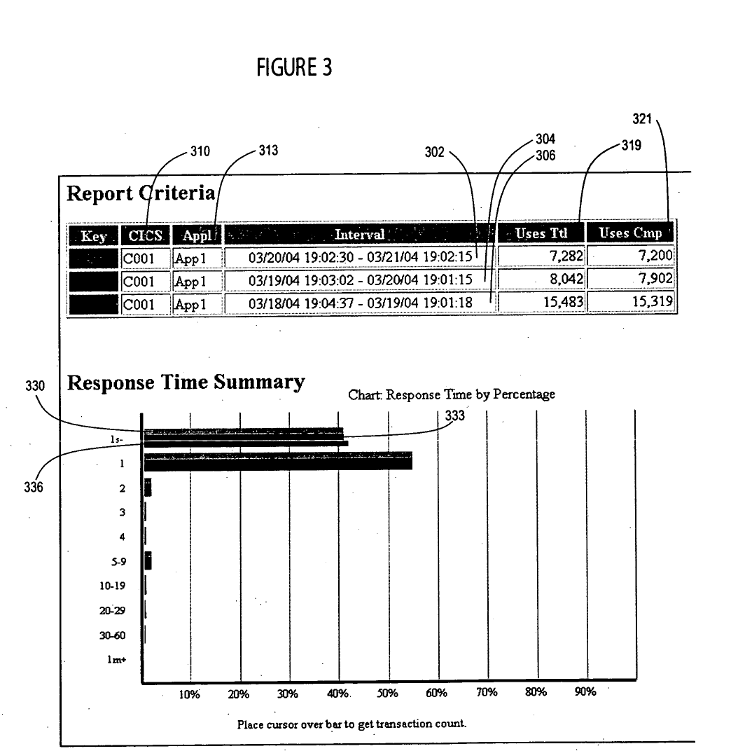

FIG. 3 shows a graphical report provided by a database 109 management application and presenting operational characteristics of an executable application determined by the system of FIG. 2. The report may be accessed and viewed either online or as hardcopy following printing. The graphical report shows a number of response time occurrences associated with user access of an executable application (Appl—item 313). The response time occurrences are grouped in ten bands ranging from under one second to over minute expressed as a percentage of the total number of occurrences graphed. The report shows response times experienced by user C001 (310) during 3 different periods (302, 304 and 306) individually graphed for each response time band. Column 319 shows the number of response time occurrences recorded in the three time periods 302, 304 and 306. Column 321 shows the number of response time occurrences actually graphed in the three time periods 302, 304 and 306.

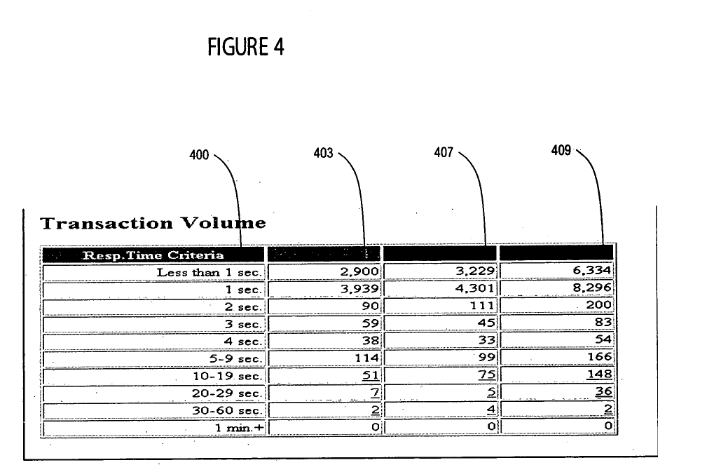

FIG. 4 shows a tabular report of the response time characteristics of an executable application presented in the graphical report of FIG. 3. Column 400 shows the ten response time occurrence bands ranging from under one second to over 1 minute. Columns 403, 407 and 409 shows the number of response time occurrences for each response time band for the three time periods 302, 304 and 306 identified in FIG. 3. Within the table, response time values that are determined to be excessive response times are displayed as underlined to indicate links representing URLs. In response to user selection of a displayed link, a detailed analysis of the excessive response times is presented. The detailed analysis provides an exact time and date of the occurrences of the excessive response times and identifies an associated user of the application responsible for the excessive response times.

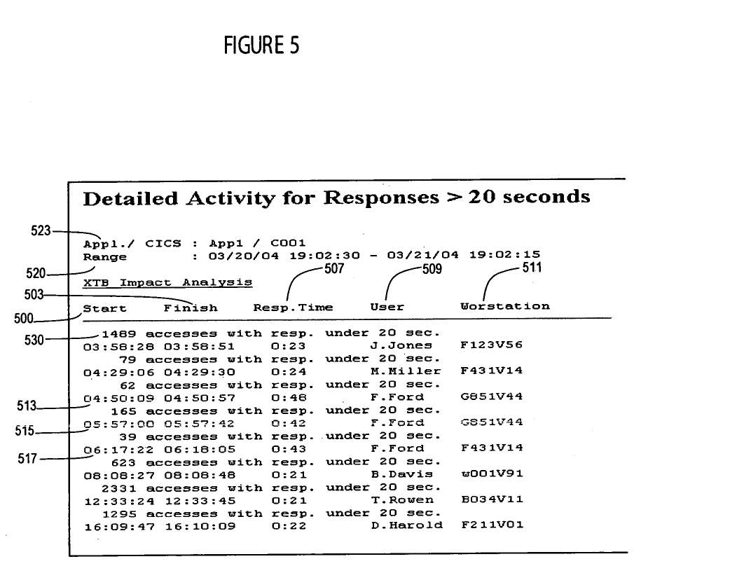

FIG. 5 shows a report presenting a detailed analysis of excessive response times associated with user access of a particular executable application 523 determined by the system of FIG. 1 over a fixed period of time 520. The report shows start and stop times in columns 500 and 503 respectively, for particular response time occurrences exceeding twenty seconds (shown in column 507) for a particular user (column 509) and workstation (column 511). These excessive response times are identified together with the number of uses (or accesses) of the application that did not have unusual response times. The report shows, for example, the number of response time occurrences that are under twenty seconds, for the same application (or the same corresponding application function), user and workstation, such as the 1489 occurrences indicated in row 530, for example. The report indicates that user F. Ford experiences response times (e.g. 48, 42 and 43 seconds in rows 513, 515 and 517 respectively) that significantly exceed the response times of users Jones, Miller, Davis, Rowen and Harold (23, 24, 21, 21 and 22 seconds respectively). Consequently, the report indicates that F. Ford is using application 523 in a manner that is different than the other users irrespective of which workstation is used. Multiple unusual response times grouped in time may indicate a response time problem within an application.

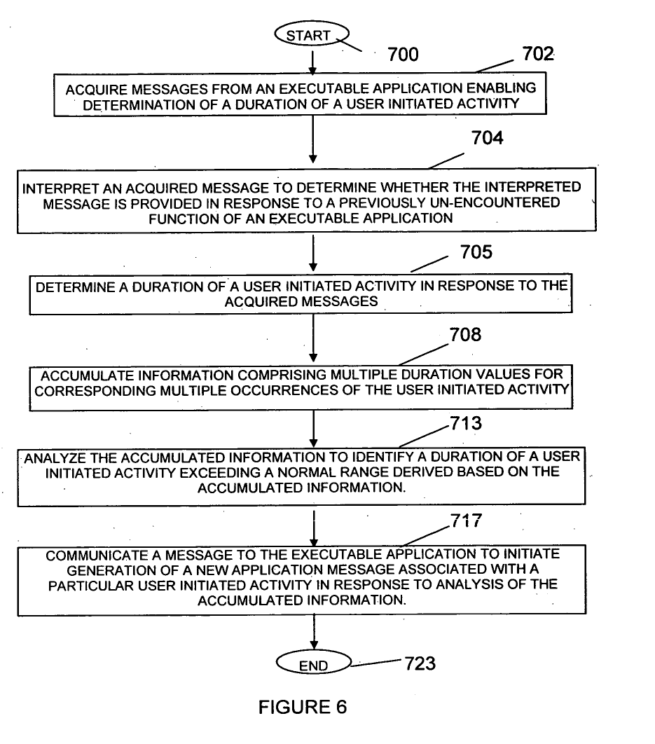

FIG. 6 shows a flowchart of a process employed by analyzer 107, operating in conjunction with a database 109 management application, for determining operational characteristics of an executable application. In step 702, following the start at step 700, unit 107 acquires messages from event log 105 derived from an executable application and enabling determination of a duration of execution of a user initiated activity by the executable application. The messages identify start of execution of the user initiated activity and completion of execution of the user initiated activity. The user initiated activity comprise one or more of, a particular function of an executable application, a particular executable procedure of an executable application and execution of a particular executable application. In step 704, unit 107 interprets an acquired message to determine whether the interpreted message is provided in response to one or more of, a function of an executable application, an executable procedure of an executable application and a user initiated activity. Analyzer 107 also determines whether the interpreted message is provided in response to a function of an executable application previously un-encountered by analyzer 107.

In step 705, unit 107 determines a duration of execution of the user initiated activity by the executable application in response to acquired messages. Analyzer 107 stores determined duration values in database 109 in step 708. Over time database 109 accumulates information comprising multiple duration values for corresponding multiple occurrences of the user initiated activity as well as information identifying a particular user initiating the activity. Analyzer 107 in step 713 analyzes the accumulated information to derive threshold values indicating a normal range of duration values. Analyzer 107 in step 713 analyzes the accumulated information to identify a duration of execution of a user initiated activity performed by the executable application exceeding the normal range derived based on the accumulated information. Analyzer 107 adaptively adjusts the normal range at predetermined time intervals in response to change in accumulated duration values in database 109. A change in the accumulated duration values in database 109 comprises growth of the accumulated information or an identified change of trend in the accumulated information, for example. Analyzer 107 initiates generation of an alert message in response to identifying the duration of execution of the user initiated activity exceeding the normal range. In step 717, analyzer 107 communicates a message to the executable application to initiate generation of a new application message associated with a particular user initiated activity in response to analysis of accumulated duration values in database 109. The process of FIG. 6 terminates at step 723.

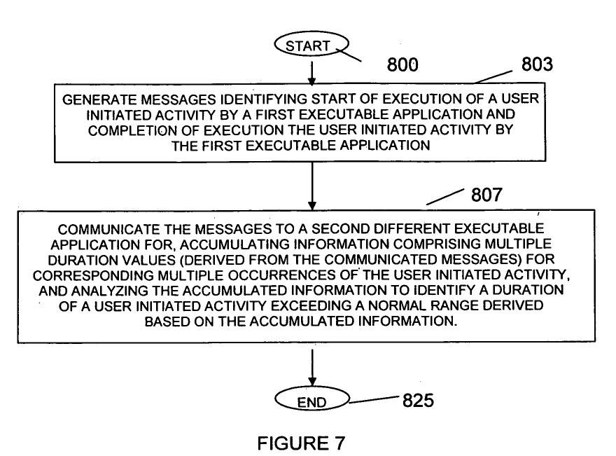

FIG. 7 shows a flowchart of a process employed by a first executable application supporting determination of operational characteristics of the first executable application. In step 803 following the start at step 800, the first application generates messages identifying start of execution of a user initiated activity by the first executable application and completion of execution the user initiated activity by the first executable application. In step 807 the first application communicates the messages to a second different executable application. The second executable application accumulates information comprising multiple duration values, derived from the received communicated messages, for corresponding multiple occurrences of the user initiated activity. The second executable application analyzes the accumulated information to identify a duration of execution of a user initiated activity by the first executable application exceeding a normal range derived based on the accumulated information. The messages identifying start of the user initiated activity and completion of the user initiated activity identify a duration of the user initiated activity. The process of FIG. 7 terminates at step 825.

The system employs activity messages generated by an application and advantageously does not require links (hooks) into an underlying operating system or application. An application may already provide such messages for auditing or security purposes and may not need any modification. In response to occurrence of an activity, the system analyzes response time data and aggregates and stores it. This allows the system to initially determine expected application behavior and allows determination of variation from the expected behavior. The system learns normal application behavior over time and adaptively adjusts an alerting process in response to variations from expected application behavior. The system capability of learning expected response times and adapting to variation in response times, reduces required application implementation and support manpower. This capability also minimizes the need to adjust response time alert thresholds when monitoring a wide variety of different executable applications.

The system is applicable to computing processes that provide a message indicating a user is initiating an activity in an executable application (and providing an activity start time) as well as a message indicating the user activity is complete (and providing an activity end time). The system may be used for monitoring mainframe batch processing, UNIX or Windows-based processing or proprietary system processing in any field not just healthcare, for example. The system is able to provide response times where acquisition or implementation of other monitoring systems is burdensome, e.g., due to software licensing, infrastructure implementation. CPU, management or configuration requirements. The system may be used by an Application Service Provider (ASP) in hosting executable applications as a service allowing remote users to generate reports and see response times of applications that are leased or rented, for example. Also for sites that purchase an application, the system may be employed as an additional application or service.

The system and processes presented in FIGS. 1-7 are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions provided by the system of FIG. 1 may be implemented in hardware, software or a combination of both and the described processes, including the processes of FIGS. 6 and 7, may be incorporated in a tangible storage medium as machine executable code comprising one or more executable applications.

1. A system for monitoring executable application operation characteristics, comprising:
an acquisition processor for acquiring messages from an executable application enabling determination of a duration of execution of a user initiated activity by said executable application;
a data processor for determining a duration of execution of said user initiated activity by said executable application in response to said acquired messages and for accumulating information comprising a plurality of duration values for a corresponding plurality of occurrences of said user initiated activity; and
a data analyzer for analyzing said accumulated information to identify a duration of execution of a user initiated activity by said executable application exceeding a normal range derived based on said accumulated information.

2. A system according to claim 1, wherein
said messages enabling determination of said duration of execution of said user initiated activity identify start of execution of said user initiated activity and completion of execution of said user initiated activity.

3. A system according to claim 1, wherein
said accumulated information includes information identifying a particular user initiating said activity and
said activity comprises at least one of, (a) a particular function of an executable application and (b) a particular executable procedure of an executable application.

4. A system according to claim 1, wherein
said accumulated information includes information identifying a particular user initiating said activity and
said activity comprises execution of a particular executable application.

5. A system according to claim 1, wherein
said data analyzer analyzes said accumulated information to derive threshold values indicating said normal range.

6. A system according to claim 1, wherein
said data processor stores said accumulated information in a repository and
said data analyzer analyzes accumulated information retrieved from said repository.

7. A system according to claim 1, wherein
said data analyzer initiates generation of an alert message in response to identifying said duration of execution of said user initiated activity exceeding said normal range.

8. A system according to claim 1, wherein
said data analyzer adaptively adjusts said normal range in response to change in said accumulated information.

9. A system according to claim 8, wherein
said data analyzer,
analyzes said accumulated information to derive threshold values indicating said normal range and
adaptively adjusts said threshold values in response to change in said accumulated information.

10. A system according to claim 8, wherein
said change in said accumulated information comprises at least one of, (a) growth of said accumulated information and (b) an identified change of trend in said accumulated information.

11. A system according to claim 1, wherein
said data analyzer adaptively adjusts said normal range at predetermined time intervals in response to change in said accumulated information.

12. A system according to claim 1, including
a message interpreter for interpreting an acquired message to determine whether said interpreted message is provided in response to at least one of, (a) a function of an executable application, (b) an executable procedure of an executable application and (c) a user initiated activity.

13. A system according to claim 1, including
a message interpreter for interpreting an acquired message to determine whether said interpreted message is provided in response to a function of an executable application previously un-encountered by said data analyzer

14. A system according to claim 1, wherein
said data analyzer communicates a message to said executable application to initiate generation of a new application message associated with a particular user initiated activity in response to analysis of said accumulated information.

15. A system according to claim 1, wherein
said normal range is for a predetermined time period.

16. A system according to claim 15, wherein
said predetermined time period is at least one of, (a) a particular portion of a day, (b) a particular portion of a week, (c) a particular portion of a month and (d) a particular portion of a year.

17. A system employed by an executable application to support monitoring of operation characteristics of said executable application, comprising:
a message generator for generating messages identifying start of execution of a user initiated activity by a first executable application and completion of execution said user initiated activity by said first executable application; and
a communication processor for communicating said messages to a second different executable application for,
accumulating information comprising a plurality of duration values for a corresponding plurality of occurrences of said user initiated activity, said duration values being derived from said communicated messages and
analyzing said accumulated information to identify a duration of execution of a user initiated activity by said first executable application exceeding a normal range derived based on said accumulated information.

18. A system according to claim 17, wherein
said messages identifying start of a user initiated activity and completion of said user initiated activity, comprise messages identifying a duration of said user initiated activity.

19. A tangible storage medium according to claim 17 embodying machine executable code comprising said executable application.

20. A system for monitoring executable application operation characteristics, comprising:
an acquisition processor for acquiring messages from an executable application identifying start of execution of a user initiated activity by said executable application and completion of said user initiated activity;
a data processor for determining a duration of execution of said user initiated activity by said executable application in response to said acquired messages and for accumulating information comprising a plurality of duration values for a corresponding plurality of occurrences of said user initiated activity; and
a data analyzer for analyzing said accumulated information to identify a duration of execution of a user initiated activity by said executable application exceeding a normal range derived based on said accumulated information.

21. A method for monitoring executable application operation characteristics, comprising the activities of:
acquiring messages from an executable application enabling determination of a duration of execution of a user initiated activity by said executable application;
determining a duration of execution of said user initiated activity by said executable application in response to said acquired messages;
accumulating information comprising a plurality of duration values for a corresponding plurality of occurrences of said user initiated activity; and
analyzing said accumulated information to identify a duration of execution of a user initiated activity by said executable application exceeding a normal range derived based on said accumulated information.

22. A method for monitoring executable application operation characteristics, comprising the activities of:
acquiring messages from an executable application identifying start of execution of a user initiated activity by said executable application and completion of said user initiated activity;
determining a duration of execution of said user initiated activity by said executable application in response to said acquired messages;
accumulating information comprising a plurality of duration values for a corresponding plurality of occurrences of said user initiated activity; and
analyzing said accumulated information to identify a duration of execution of a user initiated activity by said executable application exceeding a normal range derived based on said accumulated information.
